(19) United States
(12) Patent Application Publication
(10) Pub. No.: US 2022/0044133 A1
(43) Pub. Date: Feb. 10, 2022

(54) DETECTION OF ANOMALOUS DATA USING MACHINE LEARNING

(71) Applicant: SAP SE, Walldorf (DE)

(72) Inventors: Michael Otto, Wiesloch (DE); Min-Ho Hong, Walldorf (DE); Markus Umlauff, Stutensee-Blankenloch (DE); Lars Vogelgesang-Moll, Heidelberg (DE)

(73) Assignee: SAP SE, Walldorf (DE)

(21) Appl. No.: 16/988,528

(22) Filed: Aug. 7, 2020

(51) Int. Cl. G06N 5/04; G06N 20/00; G06K 9/62

(52) U.S. Cl. CPC G06N 5/04; G06N 20/00; G06K 9/6257; G06K 9/6212; G06K 9/627

(57) ABSTRACT

Techniques and solutions are described for analyzing data collections to determine if they may be anomalous as compared with other data collections. For example, one or more values for data elements of a data collection may be unusually high or low, or may represent infrequently occurring values. Or, values of data elements in a data collection may not be anomalous when considered individually, but may be anomalous in combination. A machine learning model is trained with training data collections, where the training data collections include a plurality of data elements. An inference data collection, also having the data elements of the training data collections, is analyzed using the trained machine learning model to provide an anomaly score. The anomaly score can be based at least in part on feature anomaly scores, which indicate anomality of individual data elements of the inference data collection.

### FIELD

The present disclosure generally relates to analyzing collections of data elements. Particular implementations relate to determining whether a data collection may be anomalous using a machine learning technique.

### BACKGROUND

Many types of computing systems and enterprises use vast amounts of structured data. Often, the structured data represents particular digital or analog-world objects, such as entities in a relational database system. In many cases, values for various elements of structured data, such as table attributes, have values that fall within a “normal” range. In addition, structured data may have combinations of data elements that fall within expected ranges or patterns. That is, a first data element having a value in a first range may typically be associated with a second data element having a value in a second range, while a first data element having a value in a third range may typically be associated with a second data element having a value in a fourth range. Identifying data that has anomalous values or combinations of values can be challenging. Accordingly, room for improvement exists.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and solutions are described for analyzing data collections to determine if they may be anomalous as compared with other data collections. For example, one or more values for data elements of a data collection may be unusually high or low, or may represent infrequently occurring values. Or, values of data elements in a data collection may not be anomalous when considered individually, but may be anomalous in combination. A machine learning model is trained with training data collections, where the training data collections include a plurality of data elements. An inference data collection, also having the data elements of the training data collections, is analyzed using the trained machine learning model to provide an anomaly score. The anomaly score can be based at least in part on feature anomaly scores, which indicate anomality of individual data elements of the inference data collection.

A method is provided of obtaining an inference result for an inference data collection having a plurality of data elements, where the inference result includes one or more values indicating whether the inference data collection, or values for data elements thereof, may be anomalous. A request for an anomaly score for an inference data collection is received. The inference data collection is received. The inference data collection includes a plurality of features, each feature being associated with a data type, such as a numerical data type or a non-numerical data (e.g., a categorical data type). The inference data collection can be an instance of one or more types of structured data.

An anomaly score for the inference data collection is calculated using a machine learning model. The anomaly score indicates a relative difference between the inference data collection and a plurality of training data collections used to train the machine learning model. The anomaly score represents a combination of feature anomaly scores for at least a portion of the features of the inference data collection, where the training data collections also comprise the plurality of features. An inference result is returned in response to the request. The inference result incudes at least a portion of the feature anomaly scores.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 illustrates a table having information, or data elements, which can correspond to attributes or columns of the table, for data collections, or rows or entities, of the table.

FIG. 2 illustrates how data elements, such as attributes of a table, can have data types and can have values that are enumerated or otherwise subject to constraints.

FIG. 3A is a flowchart of a method for training a machine learning model that can be used to analyze inference data for anomalies.

FIG. 3B is a flowchart of a method of using a machine learning model produced using the method of FIG. 3A to obtain an anomaly score for an inference data collection.

FIG. 4 is a diagram illustrating an example of information usable to train a machine learning model, such as in the process of FIG. 3A, and information calculated in providing an anomaly score, such as in the method of FIG. 3B.

FIG. 5 is a schematic diagram illustrating how values used as input for a machine learning model, either to train the model or for classification, can be associated with features.

FIG. 6 is a schematic diagram illustrating how values used as input for a machine learning model, either to train the model or for classification, can be associated with features, and how different features can contribute to a result in differing degrees.

FIG. 7 is matrix illustrating dependency information between features used as input for a machine learning model.

FIG. 8 is a schematic diagram illustrating a process for classifying relationships between data using a machine learning classifier trained using a sample set of the relationships annotated by a user.

FIG. 9 is an example system architecture for a computing system in which at least certain disclosed innovations can be implemented.

FIG. 10 is a flowchart of a method for obtaining an anomaly score for an inference data collection.

FIG. 11 is a diagram of an example computing system in which some described embodiments can be implemented.

FIG. 12 is an example cloud computing environment that can be used in conjunction with the technologies described herein.

### DETAILED DESCRIPTION

### Example 1—Overview

Many types of computing systems and enterprises use vast amounts of structured data. Often, the structured data represents particular digital or analog-world objects, such as entities in a relational database system. In many cases, values for various elements of structured data, such as table attributes, have values that fall within a “normal” range. In addition, structured data may have combinations of data elements that fall within expected ranges or patterns. That is, a first data element having a value in a first range may typically be associated with a second data element having a value in a second range, while a first data element having a value in a third range may typically be associated with a second data element having a value in a fourth range. Identifying data that has anomalous values or combinations of values can be challenging.

Even if a collection of data elements is identified as anomalous, this information may be of limited use. For example, if a user is notified that a data collection is anomalous, the user may have to manually examine the data elements in the data collection to determine why the data collection was identified as anomalous. Particularly if the anomaly results from the interaction of multiple data elements or a combination of multiple data elements to an overall anomaly score, it may be difficult for a user to identify the cause of the anomaly. Accordingly, room for improvement exists.

The present disclosure provides techniques for identifying anomalous data collections. A data collection can be a collection of data elements (or features, such as attributes of a table), at least a portion of which have some semantic relationship. A data collection can be, for example, a particular entity of a relational database system, or a collection of attributes for multiple related entities. Instances of composite or abstract data types, or other types of software or data objects, can also be data collections.

In general, the disclosed techniques can be applied to structured data, where the elements of the structured data are associated with a type (e.g., a data member, data element, attribute, key of a key value store, etc.) that is common between different data collections (e.g., instances of a particular type of data collection). Typically, at least some of the data elements in a data collection have a relationship, such as a value of one data element influencing or being associated with a value of another data element. In at least some cases, at least some data elements in the data collection can have values that are independent of other data elements, but are typically still associated with values within a typical range or set of possible values.

A machine learning model is trained using a training data set. Examples of machine learning models include techniques such as a statistical Z-score or more complex machine learning techniques such as neural networks or other types of classifiers. Techniques such as Z-scores can be beneficial as they can detect anomalous data using relatively low amounts of computing resources and can be unsupervised (e.g., the technique does not require a user to label training data).

Inference data can be analyzed using the trained model to provide an anomaly score. For example, the interface data can be submitted to a trained classifier or a Z-score can be calculated using variables (e.g., mean, standard deviation) calculated using the training data. The anomaly score provides an indication of how consistent a given data collection is with the training data set.

As discussed above, in at least some cases, having only an anomaly score can be of limited use, as it can be difficult to determine what value or values contribute to anomalous data. Accordingly, disclosed technologies provide information regarding the relative contribution of data elements, or input features, to an anomaly score. In the case of a Z-score, the Z-score can represent the magnitude of a vector whose elements corresponds to anomaly scores for particular data elements of a data collection. Thus, the values of the vector elements provide information as to which data elements contribute most strongly to anomalous data. In the case of classification techniques, contributions of individual features can be determined or estimated using SHAP values, LIME values, or similar methods.

Particularly when a data collection has a large number of data elements, it can be beneficial to present the most relevant anomaly contributions to a user. So, disclosed techniques can include features such as determining a top n (n is a positive integer) data elements that contribute to an anomaly score or determining data elements whose contribution to an anomaly score exceeds a threshold (e.g., return all data elements that contribute at least 10% to the anomaly score).

Anomaly scores, and components thereof, can also be used in user interface displays. For example, if a user interface includes a display of data elements of a data collection, the user interface display can highlight anomalous data elements or enable functionality for such data elements, such as forward navigation to a screen that provides additional details for such data elements and possibly related data elements. Making navigation available for possibly anomalous data elements can be useful, as data collections used in enterprise-level software applications can often have a very large number of data elements.

In addition to identifying anomalous data, it may be beneficial to suggestion data corrections or automatically correct data. For example, in the case when Z-scores are used to calculate anomaly scores, average values for individual features in the training data set can be used as suggested values for anomalous data elements. Techniques such as association rule learning (or mining) can also be used to suggest alternative values for anomalous data elements of a data collection. As an example, assume that data element A of a data collection has a value of X, and that value is identified as strongly anomalous. Assume further that data elements B and C are not anomalous, and that an association rule is determined that a value of Y for data element B and a value of Z for data element C are typically associated with a value of W for data element A. If the data collection has values of Y and Z for data elements B and C, the association rule can be used to suggest a value of W, instead of X, for data element A.

The above techniques can be used with a variety of data types, including numerical data elements (i.e., data elements that are natively associated with numeric values) or non-numerical structured data elements, including categorical data types. A categorical data type can be a data type that has a number of fixed or otherwise typically recurring values. For example, if a data collection represents vehicles, the vehicles in a set of data collections (e.g., entities or instances of a vehicle class) may be limited to a fixed set of colors. Or, categorical data can include open sets (e.g., new colors can be added to a data set), but values for the data element frequently fall within a particular domain (set of possible values).

Other types of non-numeric data can be used that might not be considered categorial, such as text (string) values. However, the text typically is structured, such being text associated with a particular purpose/semantic, such as an error description, a name, elements of an address, etc. Typically, non-categorical data has some elements that repeat or otherwise has values from which anomalous values can be determined. In the example of names, for instance, while many different names may exist, some names may be more common than others, and some values such as “#@*MM” may be clearly anomalous.

The present disclosure includes techniques that can be used to convert categorical or other non-numeric data types into numeric representations that can be used with various machine learning techniques. In the case of categorical data elements, a vector can be formed whose data elements represent possible values for the data element. One-hot encoding can be used to represent the value for that data element for a particular data collection. In the case of strings, one-hot encoding can be used, where a vector having twenty-six elements (one for each letter of the alphabet, when the Roman alphabet is used) can be used for each character in each word or other element of the non-numeric data element. This technique is further described in U.S. Pat. No. 10,375,120, incorporated by reference herein. Additional techniques for converting collections of words, or similar semantic elements, to numeric forms or forms otherwise suitable for processing using machine learning techniques are described in U.S. Pat. No. 10,558,554, incorporated by reference herein.

As described above, the results of the anomaly score can be presented to a user, or to provide suggested corrected values to a user. However, in other cases the anomaly scores can be used in another manner. For example, anomalous data can be flagged or otherwise annotated as anomalous. Anomalous data can be deleted (or excluded from a data collection, or from processing), or flagged for review by a user or another computing process. Anomalous data can be automatically corrected, including if an overall anomaly score, or anomaly score component, exceeds a threshold value and a replacement value can be determined (such as with sufficient confidence, including using techniques such as association rule mining).

Disclosed techniques can be used during data entry in a user interface. For example, as a user enters in data, an alert can be provided if values entered to date might result in an overall anomalous data collection. In particular, disclosed techniques can be combined with other methods to determine whether constraints on data collections are satisfied, including techniques disclosed in U.S. Patent Publication No. 2019/0303472, incorporated by reference herein.

### Example 2—Example Data Collection and Data Elements Thereof

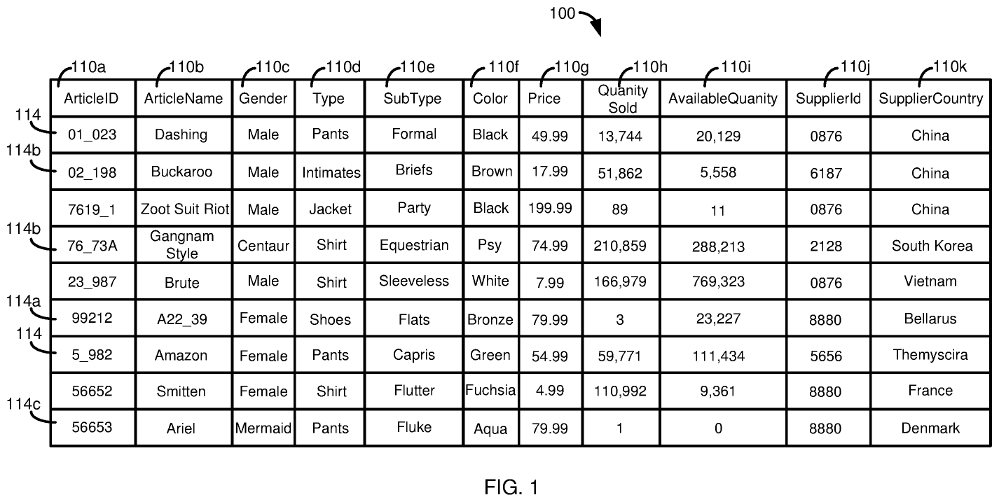

FIG. 1 shows a table 100 representing an example set of data collections of data elements that can be analyzed using disclosed techniques. The table 100 represents a particular type of structured data. As discussed in Example 1, disclosed techniques can be used with other types of data collections, such as instances of classes or types of abstract data types, compositive data types, key-value collections, and data collections represented in markup languages such as XML or formats such as JSON or CSN.

The table 100 includes a plurality of attributes 110, shown as attributes 110a-110k. In general, the table 100 can represent articles of clothing, such as articles of clothing that may be sold by a particular retailer. The attributes 110a-110k can represent various properties of a given article of clothing. Attribute 110a represents an article identifier, and is shown as a numeric/alphanumeric value. Values of the attribute 110a may serve to uniquely identify an article of clothing, and so may not be correlated with values for other attributes 110. In addition, it can be seen that the values of the attribute 110a do not have the same form. Accordingly, it may be more difficult to use the attribute 110a to identify anomalous data collection (e.g., entities of the table 100, corresponding to rows 114 of the table). However, values of the attribute 110a may still serve to identify potentially anomalous data, as values such as “***12%” are still quite different than the values shown in the table 100.

Attribute 110b can represent a name of a clothing item. It can be seen that the values for the attribute 110b are generally single words or short phrases. As with attribute 110a, it might be expected that the values of the attribute 110b would be unique, or at least substantially non-repetitive. However, values of the attribute 110b may still be used to identify anomalous data collections, in at least some cases. For example, assume that all of the data in the table 110 served as training data, with the exception of row 114a, which serves as inference data. The value for the attribute 110b for row 114a does not correspond to a word or phrase, and so could be identified as anomalous. For similar reasons as attribute 110a, it may be difficult to correlate values of the attribute 110b with values of the other attributes 110a.

Attributes 110c, 110d, 110e, 110f, and 110k represent, respectively, a gender associated with the article of clothing (e.g., men's pants versus women's pants), a type of the article of clothing (e.g., shirt, pants, shoes), a subtype of article type (e.g., slacks versus jeans), a color of the article of clothing, and a country of origin for the article. The attributes 110c, 110d, 110e, 110f, and 110k are categorical attributes (or data elements), in that the values for these attributes are typically within a fixed set of values, or at least a set of values where at least some values in the set repeat among data collections. These categorical attributes can be used to identify data collections with anomalous values, and at least some of the categorical attributes may have a relationship such that, while individual values of individual attributes may not be anomalous, a particular set of values for a set of categorical attributes may be anomalous.

Consider attribute 110c, representing a primary gender associated with the article of clothing. Expected values may be “male” or “female,” and thus rows 114b and 114c may be identified as potentially anomalous as they do not contain one of those two values. Similarly, the subtype attribute 110e may have a set of expected values, such that row 114c may be identified as potentially anomalous as having a value that occurs relatively infrequently, including having a value that was not present in data used in training a machine learning model used for anomaly detection.

As an example of how combinations of attribute values may indicate an anomalous data collection, consider possible interactions between attributes 110c and 110e. That is, the value of “capris” or “blouse” for attribute 110e may typically be associated with a value of “female” for attribute 110c. If a data collection has values of “male” and “capris” for attributes 110c, 110e, the data collection might not be identified as anomalous if the values are considered individually. However, a trained machine learning model may identify that the combination of “male” and “capris” may be anomalous. In addition, techniques, such as association rule mining, may be used to suggest that the correct value for attribute 110c, in this example, is “male.”

Attributes 110g-110j are numeric attributes. Training data can be used to indicate whether a value of such attributes is anomalous compared with values observed in a set of training data. In addition, at least certain numeric attributes may have additional constraints, such as being integers, being greater than zero, being greater than or equal to one, being within a specified range, etc. Further note that some numeric attributes, such as attribute 110j, may be considered as categorical attributes rather than numeric attributes. That is, attribute 110j represents a supplier ID, which may not be constrained to be unique values, and thus a given supplier ID may appear multiple times in the table. In such cases, it may be desirable to process attributes such as attribute 110j as categorical attributes rather than numeric attributes, at least in techniques where such attribute types are processed differently.

As will be further explained, disclosed techniques can calculate an anomaly value for a particular data collection (in this case, a row 114). The anomaly score can represent an overall deviation from values that might be expected for the data collection, either considered individually or in combination. In at least some cases, the anomaly score can represent a combination of anomaly scores for individual attributes 110. The combination can be a sum or some other combination or aggregation of attribute anomaly scores, where the scores or combination may or may not take into account relationships between attributes. When the anomaly score represents a combination of scores for individual attributes 110, the attributes can contribute equally to the overall anomaly score, or the scores for individual attributes can be weighted differently. When different weightings are used, the weightings can be determined or adjusted based on empirical data, or through input provided by a domain expert. For example, a domain expert may identify that attributes 110c and 110e are more probative of an anomalous article of clothing than attribute 110b or attribute 111d.

Note that all data elements of a data collection need not be considered in determining an anomaly score. For example, if the article ID is unique, and is not constrained to a particular format, it can be omitted from anomaly detection processing.

### Example 3—Example Data Types for Data Elements of Data Collections

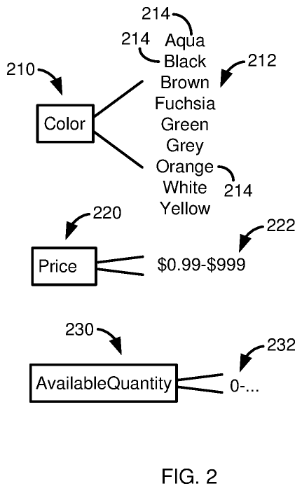

FIG. 2 illustrates how attributes, or other types of data elements, can be associated with different data types, such as numeric or categorical data types. In particular, FIG. 2 illustrates three attributes 210, 220, 230. The attributes 210, 220, 230 can correspond to the attributes 110f, 110g, 110i of FIG. 1.

Attribute 210 is a categorical attribute, and is shown as having a domain, or set, 212 of values 214. An anomaly score for the attribute 210 can be based on whether a value for the attribute in a particular data collection is within the domain 212, or based on a frequency at which the value occurs in a set of training data.

Attribute 220 is a numeric attribute, and is associated with a numeric value range 222. An anomaly score for the attribute 220 can be based on whether a value of the attribute 220 for a particular data collection is within the range 222, or based on comparing the value with a value determined from the training data, such as an average value, using a Z-score, or implicitly or explicitly based on a machine learning model.

Attribute 230 is also a numeric attribute, and is associated with a numeric value range 232. While the range 222 for the attribute 220 was constrained at the upper and lower bounds, the range 232 is only constrained by the lower bounds as shown. However, the range 322 can be subject to other constraints, including constraints that do not apply to the range 222. For example, the range 232 may be constrained to integer values, while range 222 may not be so constrained. An anomaly score for the attribute 230 can be based on whether a value of the attribute 230 for a particular data collection is within the range 232, or based on comparing the value with a value determined from the training data, such as an average value, using a Z-score, or implicitly or explicitly based on a machine learning model.

### Example 4—Example Techniques for Training and Use of Machine Learning Models

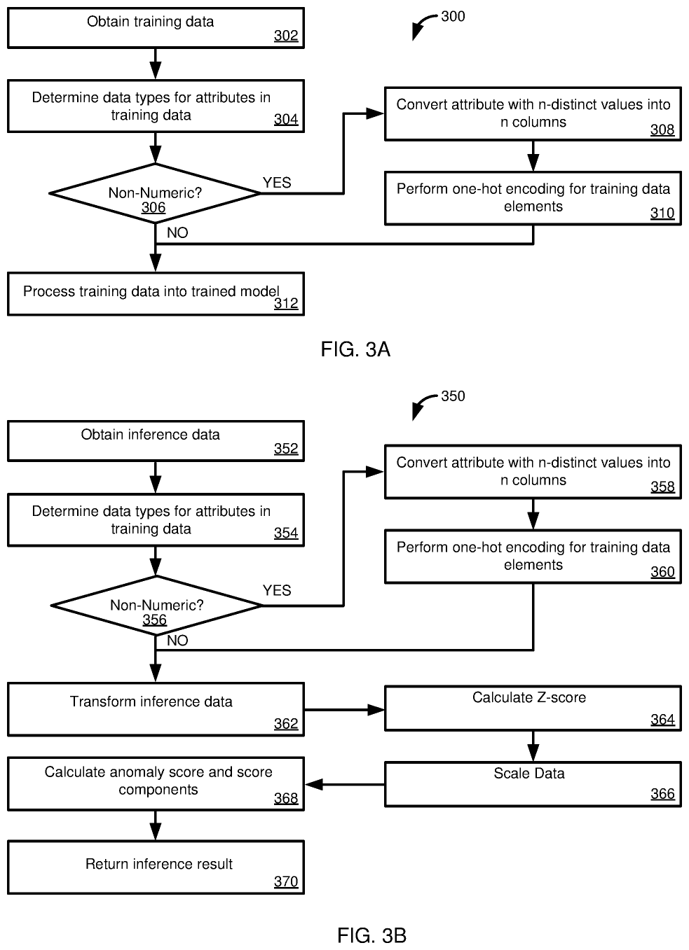

FIG. 3A is a flowchart of an example method 300 for training a machine learning model that can be used to calculate an anomaly score for a data collection, and contributions to such score by individual data elements. The trained model can be used in a method 350 for obtaining an anomaly score (and contributions of data elements thereto) for inference data, shown in FIG. 3B.

At 302, training data is obtained. The training data can be all or a portion of data elements of multiple data collections. For example, data elements that do not have consistent values (e.g., a primary key or other unique identifier) or otherwise are not probative of anomalous data collections, either alone or in combination with other data elements, can be omitted from processing. Obtaining training data at 302 can include querying a database or repository for data elements of data collections of a particular type or types (e.g., data from a particular table or from a collection of tables, where data from multiple tables has some semantic relationship).

Data types for attributes in the training data can be determined at 304. For example, it can be determined whether any data types are, or should be treated as, numeric data types or categorical data types or other types of non-numeric data types. At 306, it is determined if any attributes with non-numeric data types are present in the training data. If so, the method 300 proceeds to 308, which begins a process of converting non-numeric data types to numeric data types.

At 308, an attribute is processed that has n distinct values, where n is a positive integer greater than or equal to one. The number of distinct values is the set of domain of values that exist in the training data set or the number of distinct values to which an attribute might be constrained. In some cases, such as for attributes of a relational database, the attribute may be constrained by a definition of the attribute (e.g., a data element as used in system of SAP SE, of Walldorf, Germany). The definition of the attribute, such as in a data dictionary or an information schema, can be consulted to determine constraints for the attribute. Examples of how data dictionaries or information schemas can specify values for attributes are described in U.S. patent application Ser. No. 16/865,021, filed May 1, 2020, incorporated by reference herein.

The attribute is then converted into n-attributes, columns, or vector elements. For example, if an attribute is constrained to five values (e.g., for a color attribute where five colors are available), five attributes or columns are created. Or, a vector or tuple can be created having five elements, where each element represents a particular color value. Note that if new values are detected for a data element, or if the inference data collection contains a value that is not in the training data set during execution of the method 350, an additional index/vector element can be created for the new value, and the mean and standard deviation calculated for that index/vector element.

One-hot encoding is performed for each of the n-vectors at 310 for data collections of the training data. In the one-hot encoding, vectors elements are set to one if a particular data collection has the value of that data element that corresponds to the given vector element, and zero otherwise. So, assuming that a data element has possible values of blue, green, red, yellow, and white, a data collection having a value of red for that data element could be represented as [0,0,1,0,0]. After 310, or if it is determined at 306 that the data collection does not include non-numeric data types, the method 300 proceeds to 312.

At 312, the training data is converted into a trained model. When the machine learning technique uses a Z-score, 312 can include calculating a mean and a standard deviation for numeric attributes and for each of the n-columns of any non-numeric attributes. As will be explained in the discussion of the method 350, the mean and standard deviation serve as the machine learning model that can be used to evaluate inference data collections. The method 300 can then end, in the case where a Z-score or similar technique is used.

When other machine learning techniques are used, such as neural networks or other types of classifiers, various changes can be made to the method 300. For example, processing the training data at 312 can include submitting the data collections in the training data, including non-numeric attributes processed as in 308, 310, to a suitable machine learning algorithm. In some cases, rather than using the one-hot encoding technique of 308, 310, other text encoding schemes can be used to convert non-numeric values to numeric values that can be processed by a machine learning algorithm, such as the techniques described in Example 1 or dictionary encoding. When the machine learning algorithm is a supervised machine learning technique, an anomaly score or anomaly indicator can be assigned to data collections of the training data, including to individual data elements of such data collections. The anomaly scores or indicators can be quantitative or qualitative (e.g. high, medium, low) indicators of how anomalous data might be.

In the method 350 of FIG. 3B, inference data is obtained at 352. The inference data can be a data collection of the same type as data collections used for model training in the method 300. In some cases, the inference data can be obtained in similar manners as described for obtaining training data (e.g., querying a database). Other ways inference data can be received include having a data collection provided as part of a function or method call (e.g., as an argument), including to a method of an application program interface. Although processing of inference data in the method 350 is described as occurring for a single data collection, an inference request can include, or specify, multiple data collections for which inference results are desired. The multiple requests can be processed serially or in parallel, depending on implementation.

Data types for attributes (or other types of data elements) in the training data can be determined at 354, which can be carried out in analogous manner as 304. At 356, it is determined if any non-numeric data types are present. If so, they can be converted to numeric data at 358, 360, which can be carried out as described for 308, 310. After processing at 360, or if it is determined at 356 that no non-numeric data types are present, the method 350 proceeds to 362.

The, optionally processed, inference data is transformed at 362. The transformation enables anomaly scores for different attributes to be compared with one another. That is, values for the attributes can be standardized or scaled such that anomaly scores are comparable between attributes, although the anomaly scores can optionally be weighted to reflect a higher likelihood of a particular attribute indicating an overall anomalous data collection.

As has been described, the calculation of a Z-score is one method by which two data sets having different ranges or distributions can be compared with one another. Accordingly, transforming the data set can include calculating a Z-score using operations carried out at 364, 366. In particular, at 364, a Z-score is calculated for each attribute, including numeric attributes created as a result of converting non-numeric attributes to numeric attributes. The Z score is calculated as the value for the attribute in the data set minus the mean determined during model training divided by the standard deviation, or:

$$Z = \frac{x - μ}{σ}$$

where Z is the Z-score, x is the attribute value for the inference data, μ is the mean of the attribute values of the training data, and σ is the standard deviation of the values in the training data.

Once the Z-scores have been calculated for a particular attribute, they can optionally be scaled relative to one another at 366. For example, issues may arise in comparing numeric and categorical features, given that numeric attributes may have a wider range of values than one-hot encoded non-numeric attributes. In addition, the weights can be used to scale non-numeric attribute to take into account that different non-numeric attributes may have different numbers of distinct values (and thus more columns may be recombined to provide an overall anomaly score for a decoded non-numeric attribute).

Various scaling factors can be used, and the scaling factors can be the same or different between numeric and non-numeric attributes. For numeric attributes, a constant can be applied to the calculated Z-score. In some cases, the constant can simply be 1. For non-numeric columns, a weighting factor can be:

$$\frac{1}{\sqrt{{k}_{i}}} \qquad ( 1 )$$

where kᵢ is the number of distinct values k in an unencoded non-numeric attribute i. More specifically, k is the number of possible distinct values or the number of distinct values in the combination of the training data set and the inference data.

The anomaly score for the inference data can be calculated at 368. In a particular example, the anomaly score is calculated as a p-norm of a vector having as elements the scaled Z-scores of the attribute values of the training data, including all columns for encoded non-numeric attributes. In a more particular example, the p-norm is calculated as the Euclidian norm (i.e., p=2), as the square root of the sum of squares of the individual Z-scores. In other cases, other values of p, such as 1, values of p between 3 and infinity, or a value of infinity can be used to calculate the Z-score. A value of p can be hard coded into software that carries out an anomaly score calculation/anomaly detection technique of the present disclosure, or such a value can be user-configurable. In cases where p is user-configurable, a user can empirically determine a value of p that provides suitable results for a given application (e.g., a particular type of data collection).

Inference results can be returned, such as to a user or calling process, at 370. Inference results can include different information depending on a particular implementation or configuration of the method 350. For example, one or more of an overall anomaly score and contributions of one or more attributes to the anomaly score can be provided, optionally with additional information regarding any such individual attributes, such as the name of such attributes and the data type (numeric, categorical, etc.) of the attribute.

If individual attribute scores are returned, it can be useful to limit the number of values returned, or displayed to a user. For example, it can be common for some tables or data objects, which can serve as data collections, to have tens or more of attributes/data members. In order to help identify a source of an anomalous result, it may be useful to limit information regarding individual attributes to a top n number of attributes (n is a positive integer), attributes contributing at least a certain threshold percentage to an overall anomaly score, using other criteria, or using combinations of these criteria. An overall result (e.g., yes/no) indicating whether a data collection is anomalous can also be provided, such as if the anomaly score satisfies a threshold score used to define anomalous data. In some cases, contributions of individual attributes to an anomaly score are only returned when an overall result (yes/no, or a total anomaly score that satisfies as threshold) indicates a potentially anomalous data collection.

In returning an inference result, it may be desirable to join data in an inference data collection with other data. For example, some of the attributes in the inference data collection may be coded, where the human-understandable description of an attribute value is stored in another table (e.g., in master data or in a description of dimension values).

Various modifications can be made to the method 350 if a machine learning technique is used other than the Z-score or a similar technique. For example, rather than transforming inference data at 362, the inference data, optionally processed to encode any non-numeric attributes, can be submitted to a classifier at 368 to obtain a classification result. The classification result can include one or more of an overall score, an overall result (yes/no), or information about individual contributions to an overall result or information regarding interactions or correlations between attributes, as will be further described in Examples 6 and 7.

### Example 5—Example Training and Use of Machine Learning Model to Calculate an Anomaly Score

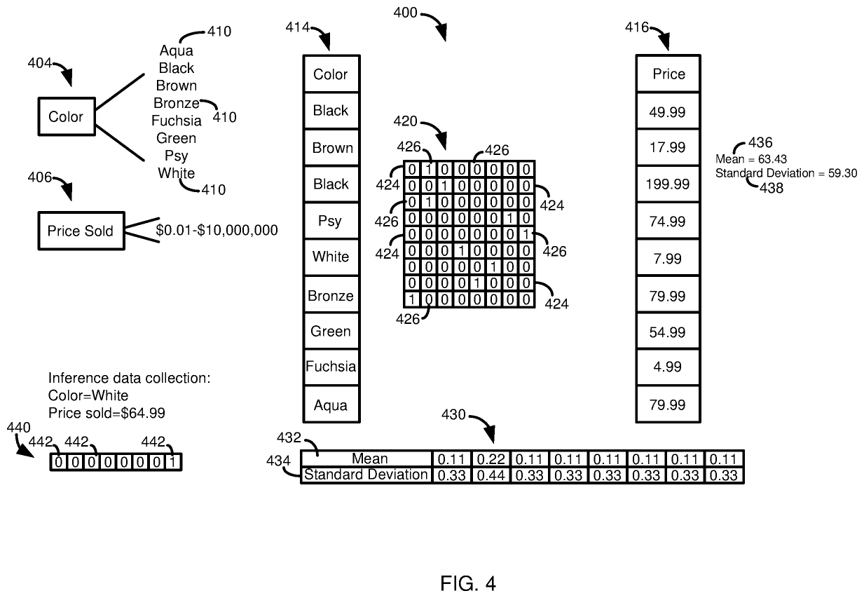

FIG. 4 illustrates a scenario 400 that represents a particular example of how an anomaly score can be calculated for a data collection. In general, the scenario can use a model trained as described in the method 300 of FIG. 3A and can obtain an inference result using the method 350 of FIG. 3B.

A type of data collection used in the scenario 400 can include an attribute 404 representing a color and an attribute 406 representing a price sold. The attributes 404 and 406 can be the attributes 110f, 110i of FIG. 1. Attribute 404 is a categorical attribute and is shown as having eight possible values 410. Attribute 406 is a numeric attribute. For purposes of this Example 5, it will be assumed that a lower bound of the attribute 404 is $0.01 and an upper bound is $10,000,000.

Column 414 represents values of attribute 404 for a training data set, and column 416 represents values of attribute 406 for the training data set. Since attribute 406 is numeric, if anomaly scores are calculated using the Z-score technique, it can be processed without any preprocessing. Since attribute 404 is non-numeric (in this case being categorical), it can be preprocessed.

In preprocessing the values for attribute 404 for the training data set, eight columns are created for the attribute—one for each distinct value available for the attribute. In other cases, rather than using the number of distinct possible values, the number of values is selected to be the number of distinct values present in the training data set. Table 420 represents a series of one-hot encoded vectors 424, where each vector represents a value for the attribute 404 for a data collection of the training data set (i.e., the values in the column 414). Each element or position 426 of the vector represents a unique value in the domain of the attribute 404 (i.e., position 0 represents ‘aqua’, position 1 represents “black,” position 2 represents “brown,” etc.). The vectors 424 are “one-hot,” in that a single position 426 of a given vector has a value of 1 (for the position in the vector representing the value held by the particular data collection of the training data set), the other elements of the vector have a value of 0.

The information for the machine learning model can include both the overall data processing techniques used in model training and in obtaining inferences, as well as mathematical constructs that capture the information from the training data set. When Z-scores are used to calculate anomaly scores, the model information is thus stored in the mean and the standard deviation for each numeric attribute of the training data set and for the collection of numeric attributes formed to encode data in non-numeric attributes. In other words, while a single mean and standard deviation is determined for attribute 406, eight means and standard deviations are determined for the encoded data of attribute 404, one for each of the vector positions 426.

Table 430 provides the means 432 and standard deviations 434 based on the table 420. Mean 436 and standard deviation 438 are calculated using the values in the column 416.

Assume that an inference result is requested for a data collection having a value of “white” for attribute 404 and a value of 64.99 for attribute 406. Z-scores can be calculated for each vector position 442 of a vector 440 for the inference data. Vector positions 442 other than those for “black,” which occurs twice in the training data, represent values that only occur once in the training data. Vector positions 442 associated with a value having a single instance in the training data and not present in the inference data have a Z-score of −0.33 ((0−0.11)/0.33), while the hot vector position 442 (position 7 of positions 0-7), representing “white,” has a Z-score of 2.70 ((1−0.11)/0.33). For vector position 442 associated with “black” (position 1), that position is not hot, and so has a Z-score of −0.50 ((0−0.22)/0.44). If the training data set includes additional non-numeric attributes, the Z-scores for a vector representing encoded values for such attributes can be calculated in a similar manner as for the attribute 406.

Calculation of the Z-score for the attribute 406 is straightforward and provides a value of 0.03 ((64.99−63.43)/59.3). Z-scores for other numeric attributes can be calculated in a similar manner as for the attribute 406.

With the Z-scores calculated, the Z-scores for the attributes, including vectors or tuples of values for non-numeric attributes, can be scaled. Assuming a constant of 1 is used for numeric columns, the scaled Z-score for the attribute 406 is 0.03. Using Equation 1 of Example 4, the weights for the Z-scores for the vector positions 442 are calculated by multiplying the values by 0.35 (1 divided by the square root of 8). In one example, an overall, scaled Z-score for attribute 404 can be calculated as 0.35 (the scaling factor)*−0.33 (Z-score)*6 (the number of non-hot attribute values representing a single time in the training data)+0.35 (the scaling factor)*2.7 (Z-score)*1 (the hot attribute value)+0.35 (the scaling factor)*−0.50 (Z-score)*1 (for the non-hot attribute value “black,” which occurs twice in the training data). This calculation provides a final scaled Z-score for attribute 404 of 0.22. The scaled Z-score can then be used in calculating the Z-score for the inference data collection.

Considering just the Z-scores for attributes 404, 406, the Z-scores make some intuitive sense, as the values for attribute 404 vary fairly widely in the training data, such that the chance of a given value occurring is close to ⅛ (0.13), which in turn is close to the Z-score. In other words, any value for attribute 404 is reasonably anomalous given the distribution of values in the training data. On the other hand, the value of 64.99 for attribute 406 is close to the mean of 63.43, as well as being close the median value of 54.99 in the training data.

As an example of how an anomaly value can be calculated, assume that training and inference data collections include an additional four attributes, that provide additional scaled Z-scores of 1.5, 0.89, 43, and 0.33 for the inference data discussed above. The overall Z-score for the inference data can be calculated as the Euclidian norm (p-norm with p=2) as the square root of the sum of the squares of the individual Z-score values, or the square root of (0.0484+0.0009+2.25+0.7921+1849+0.1089), or 43.04.

In some cases, it may be useful to calculate the anomaly score using the scaled Z-scores for encoded non-numeric attributes, rather than aggregating these scaled Z-scores as described above and using the aggregated values to calculate the anomaly score (e.g., as a Euclidian norm). In particular, it is possible that at least in some cases aggregating the scaled Z-scores for an encoded non-numeric attribute may result in a large contribution of the attribute to the anomaly score even if the scaled Z-score values are relatively small.

Accordingly, in another embodiment, the scaled Z-scores values for all numeric attributes/vectors for encoded non-numeric attributes are used in calculating the feature anomaly score. In this case, the contribution of smaller values (values less than 1) is reduced because the squares of such values (which are smaller than the original values) are aggregated in determining the Euclidian norm. Using the feature anomaly scores of 0.03 for attribute 406, the scaled feature anomaly scores for attribute 408 calculated above, and the additional scaled Z-scores provided above (assuming in this scenario that such values either represent numeric attributes or scaled Z-score values for individual vectors of encoded non-numeric attributes), the anomaly value/Z-score for the data collection would be calculated using the square root of the sum of squares approach as 43.04, which in this case provides a result that is equivalent to the previously described technique.

Higher Z-scores indicate more anomalous inference data. However, it may be difficult to know at what value of Z inference data should be labelled as potentially anomalous, or to determine a degree of anomaly. Users may manually set thresholds or ranges, such as based on their domain knowledge or by analyzing test data.

Setting thresholds or ranges can automatically be performed. In one implementation, the set of test data can be analyzed to find one or more data collections in the training data that most closely match average values for each attribute in the training data. Such data collections may represent the least anomalous data. Assuming the training data does not include anomalous data (and, in some cases it may be useful to pre-process a training data set to remove such data collections), additional information can be gathered by analyzing data points that deviate the most from the average values, or which have the highest overall Z-scores for the training data set. Values that fall outside of a set distance from the mean or high/low Z-scores of the training data set may be considered anomalous. Or, the average Z-score and standard Z-score deviation can be calculated, and data that falls outside of the average Z-score by a set amount (such as by a multiple of the standard deviation) may be considered potentially anomalous. User feedback can be used to refine classification of anomality or degree of anomality.

Note that it may be useful to carryout addition processing to separate effects from non-numerical attributes and numerical attributes, or between different attributes, generally. That is, it can be seen that the encoding method used for non-numeric attributes can produce Z-scores with lower values than for numeric attributes, particularly when the numeric attributes have large values or values within a large range (where the upper end of the range may also have comparatively large values, relative to values that can be obtained by encoding non-numeric attributes with one-hot vectors). Similarly, numeric attributes that have sufficiently different ranges or distributions may result in numeric attributes contributing to an overall Z-score in a way that overemphasis such attributes, and may not accurately reflect whether particular data is anomalous.

Take the price attribute 406 as an example, without considering other factors, it might be expected that price values for different articles of clothing can vary substantially, such as based on the nature of the clothing article (i.e., pants versus shoes) and the quality of the article (e.g., a high-end fashion brand versus a generic or discount brand). Such variation by itself may not be particularly probative of whether a given inference data collection is anomalous, although considering combinations of attributes might (e.g., considering price in combination with supplier, or price in combination with article of clothing type and supplier type). For numeric attributes, changing the scaling factor may address this problem, such as by normalizing or otherwise rescaling the data sets. Such rescaling can also be applied to non-numeric attributes.

Continuing with the example inference data set, various values may be returned in response to an inference request. Depending on implementation, one or more of an indicator of whether the inference data is considered anomalous, an indicator of a degree of anomality of the inference data, an overall Z-score, contributions of some or all of the attributes to the overall Z-score (e.g., a set number of attributes having the highest contributions, attributes exceeding a threshold contribution level), a scaled contribution of such individual attribute contributions (e.g., the attribute contribution divided by the overall Z-score), or information about any individual attribute contributions included in the results (e.g., a name of the attribute, a data type for the attribute, an average or median value for attributes identified as potentially anomalous/having a high contribution to the overall anomaly score). Depending on implementation, additional suggestions for correcting anomalous data can be provided.

Several examples will be provided to illustrates how the contributions of individual attributes (feature anomaly scores) to an overall anomaly score can provide insights into why particular data was flagged as potentially anomalous, which may also suggest how a data collection might be modified so as to not be anomalous. The examples use the Z-score anomaly detection technique described above. Each example returns an overall anomaly score for a data collection and one or more feature anomaly scores.

Additional information is provided for the anomaly score, including an indication of how the anomaly score compares with other data collections in a data set (e.g., a training data set). In particular, the anomaly score for a data collection can be compared with a data collection of a training data set having a highest anomaly score, such as by dividing the anomaly score by the reference anomaly score for the data collection to provide a relative anomaly score. If desired, the relative anomaly score can be converted to a percentage.

In the particular examples provided, a reference anomaly score of 7523 is used. The reference anomaly score is higher than the anomaly score of the inference data collections, and can represent an anomalous data collection that was present in the training data set. However, a reference anomaly score need not represent anomalous data. For example, the reference anomaly score can represent a highest anomaly score amount for data collections in the training data set for data that may be considered non-anomalous. Or, the reference anomaly score can be set manually or using a data collection identified as having a statistically significant difference from anomaly score values for other data collections (e.g., having greater than a set number of standard deviations from an average anomaly score for the data set).

In general, whether a data collection is considered anomalous, or a degree of anomality, can be determined by the difference between the reference anomaly score and an anomaly score for an inference data collection. If the reference anomaly score represents an anomalous data collection in a training data set, a relative anomaly score above 1 (i.e., above 100%) can indicate anomalous data. However, relative anomaly scores less than 1 can also indicate anomalous data, particularly when a most anomalous data collection in a training data set is used as the basis for the reference anomaly score or the reference anomaly score is otherwise associated with highly anomalous training data. In this case, a threshold can be defined such that a relative anomaly score above a particular value (e.g., 0.25 or 25%) can indicate anomalous data.

In addition, ranges of anomalous data can be defined, such as defining ranges of relative anomaly scores that are associated with slightly anomalous data, moderately anomalous data, highly anomalous data, etc. Although similar thresholds can be used with raw anomaly scores (and can be defined at least in part using a reference anomaly score) providing the relative anomaly score may more easily allow a user to understand a degree of anomality for a particular data collection (for example, if the user does not know what range of values might be “normal” for a particular data collection).

Another value that can be provided to users to indicate how an inference data collection compares with data in a training data set is a percentile or percentile range in which the data collection falls as compared with the distribution of anomaly scores in the training data set. The distribution can be stored as part of the machine learning model. The exact percentile in the distribution in which an inference data collection falls can be provided, or ranges can be defined in the training data, and the range can be included in addition to/in place of the exact percentile. When ranges are used, the ranges can be manually defined (e.g. into quartiles), or can be defined using statistical methods, such as clustering techniques.

For each feature anomaly score that is provided, additional information can be provided to help a user (or process) understand what contributed to an overall anomaly score, including the data type of the feature (e.g., numeric, categorical) as well as a relative feature anomaly score that represents the overall contribution of the feature anomaly score to the anomaly score for the data collection (e.g., the feature anomaly score divided by the anomaly score for the data collection). In some cases, rather than returning the “raw” feature anomaly score, the relative feature anomaly score, optionally along with other information such as feature data type, can be returned in an inference result.

In a first example, a first data collection is analyzed using the Z-score technique described above and inference results are returned that include:
{‘score’: 6.961717461852364,
   ‘score_rel’: 0.0009254099815668462,
   ‘percentile’: ‘0%-90%’,
   ‘contributor1’: ‘PREM_CD’,
   ‘type1’: ‘cat’,
   ‘contribution1’: 0.21895336981546032,
   ‘contributor2’: ‘SALECH_CD’,
   ‘type2’: ‘cat’,
   ‘contribution2’: 0.17372550823683192,
   ‘contributor3’: ‘PAYFRQ_CD’,
   ‘type3’: ‘cat’,
   ‘contribution3’: 0.16408047086856273}

The “score_rel” value, obtained by dividing the anomaly score for the example (˜6.961) by the reference anomaly score (7523), indicates that this first example has an anomaly score that is less than 1% of the reference anomaly score. The percentile range of 0-90% included in the inference result confirms that the feature anomaly score is within a range that include 90% of the data collections used in the training data set. Thus, the data collection of example 1 can be identified as not anomalous.

A second example returns an inference result of:
{‘score’: 482.69759904325264,
   ‘score_rel’: 0.06416422078038798,
   ‘percentile’: ‘99%-99.9%’,
   ‘contributor1’: ‘PM_ID_POLICY’,
   ‘type1’: ‘cat’,
   ‘contribution1’: 0.9864206038865994,
   ‘contributor2’: ‘PREM_CD’,
   ‘type2’: ‘cat’,
   ‘contribution2’: 0.003157860119870044,
   ‘contributor3’: ‘SALECH_CD’,
   ‘type3’: ‘cat’,
   ‘contribution3’: 0.0025055602237481966}

The data collection for this second example exhibits more anomalous behavior, given that it is about 6.4% of the reference anomaly score. Without more, however, it may be difficult for a user or process to determine whether the data collection for this second example is truly anomalous. The percentile information, indicating that the anomaly score is in a range that includes only about 1% of the data collections in the training data set, confirms that the data collection for this second example may be anomalous.

The top three features that contribute to the anomaly score of the second example are provided in the inference result. It can be seen that a single feature, PM_ID_POLICY, contributes more than 98.6% to the anomaly score, and has a categorical data type. Thus, example 2 indicates that anomalous behavior is associated with a rare categorical value, and that closer evaluation of this feature may be indicated. In cases where suggested values are provided, suggested values can be provided for PM_ID_POLICY, such as using a most common categorical value or a most common categorical value considering values for other features in the feature collection (e.g., such as using association rules).

A third example returns an inference result of:
{‘score’: 148.22827730816982,
   ‘score_rel’: 0.019703748122943832,
   ‘percentile’: ‘99%-99.9%’,
   ‘contributor1’: ‘MAX_PREMBEFORETAX_AM’,
   ‘type1’: ‘num’,
   ‘contribution1’: 0.9530829557145006,
   ‘contributor2’: ‘PREM_CD’,
   ‘type2’: ‘cat’,
   ‘contribution2’: 0.010283405606925276,
   ‘contributor3’: ‘SALECH_CD’,
   ‘type3’: ‘cat’,
   ‘contribution3’: 0.0081592252586670921

The data collection for this third example is somewhat less anomalous than the second example, being about 2% of the reference anomaly score. This data collection is also in the 99-99.9% percentile, indicating that it may still represent anomalous data. From the feature anomaly score information, MAX_PREMBEFORETAX_AM contributes over 95% to any anomalous behavior of the inference data collection, and has a numeric data type. Thus, example 3 indicates that anomalous behavior is associated with a single extreme numerical value, which can guide evaluation or correction of the third data collection.

A fourth example returns an inference result of:
{‘score’: 84.92757845284828,
   ‘score_rel’: 0.011289287340548772,
   ‘percentile’: ‘95%-99%’,
   ‘contributor1’: ‘RATESUPPB_AM’,
   ‘type1’: ‘num’,
   ‘contribution1’: 0.3712086770800179,
   ‘contributor2’: ‘MAX_PREMBEFORETAX_AM’,
   ‘type2’: ‘num’,
   ‘contribution2’: 0.26045121693392387,
   ‘contributor3’: ‘MAX_INSAMOUNT_AM’,
   ‘type3’: ‘num’,
   ‘contribution3’: 0.2122763348573788}

The data collection for this fourth example is even less anomalous than the third example, being about 1.1% of the reference anomaly score. The 95-99.9% percentile information confirms that the fourth data collection exhibits less anomalous behavior than examples 2 and 3, but may still have some degree of anomality. From the feature anomaly score information, it can be seen that in this case each of the top three features that contribute to the anomaly score do so in a significant manner (˜37%, 26%, and 21%), and that each of these features have numeric data types. Thus, anomality in this fourth example is shown to result from an unusual combination of features values. In at least some cases, the individual values for the different features might not be flagged as anomalous, but their combination can be identified as potentially anomalous.

### Example 6—Example Use of Features for Training and Use of Machine Learning Models

It can be beneficial to describe to a user how individual features used as input for a machine learning model affect an inference result provided for inference data suggested to the model (e.g., a trained classifier). This Example 6 describes example techniques for determining amounts by which various input features affect a machine learning results. Additional details regarding this technique, as well as a description of how such techniques can be used to help explain a machine learning result to a user, can be found in U.S. patent application Ser. No. 16/725,734, filed Dec. 23, 2019, and U.S. patent application Ser. No. 16/712,792, filed Dec. 12, 2019, each of which is incorporated by reference herein. While these applications describe contributions of features to a machine learning result in supervised machine learning techniques, the techniques disclosed in these applications, or similar techniques, can be adapted for unsupervised techniques, including the Z-score technique described in Example 5. For example, Antwarg, et al., describe the use SHAP values (described further below) in an unsupervised neural networks in “Explaining Anomalies Detected by Autoencoders Using SHAP,” available at https://arxiv.org/pdf/1903.02407.pdf.

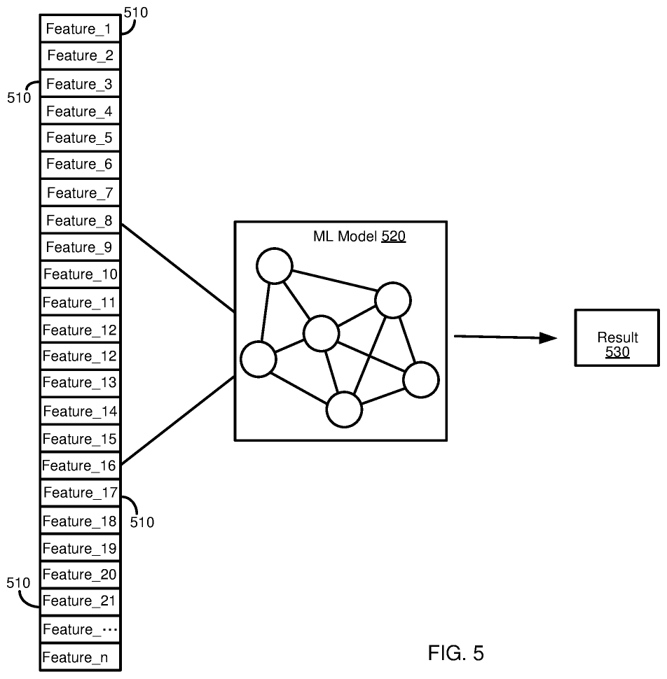

FIG. 5 schematically depicts how a plurality of features 510 (which can be attributes or other types of data elements of a data collection, as otherwise described in the present disclosure) can be used as input to a machine learning model 520 to provide a result 530. Typically, the types of features 510 used as input to provide the result 530 are those used to train a machine learning algorithm to provide the machine learning model 520. Training and classification can use discrete input instances of the features 510, where each input instance has values for at least a portion of the features. Typically, the features 510, and their respective values, are provided in a way that uses a particular feature in a particular way. For example, each feature 510 may be mapped to a variable that is used in the machine learning model.

The result 530 maybe be a qualitative or quantitative value, such as a numeric value indicating a likelihood that a certain condition will hold or a numeric value indicting a relative strength of an outcome (e.g., with high number indicating stronger/more valuable outcomes). For qualitative results, the result 530 might be, for example, a label applied based on the input features 510 for a particular input instance.

Note that for any of these results, typically the result 530 itself does not provide information about how the result was determined. Specifically, the result 530 does not indicate how much any given feature 510 or collection of features contributed to the result. However, in many cases, one or more features 510 will contribute positively towards the result, and one or more features may argue against the result 530, and instead may contribute to another result which was not selected by the machine learning model 520.

Thus, for many machine learning applications, a user may be unaware of how a given result 530 relates to the input features for a particular use of the machine learning model. If users are unsure what features 510 contributed to a result 530, or to how or to what degree they contribute, they may have less confidence in the result. In addition, users may not know how to alter any given feature 510 in order to try and obtain a different result 530. In examples provided in the present disclosure, a user may not know what attribute values to correct, or how to correct them,

In at least some cases, it is possible to determine (for an individual classification results as an average or other statistical measure of a machine learning model 520 over a number of input instances) how features 510 contribute to results for a machine learning model. In particular, Lundberg, et al., “Consistent Individualized Feature Attribution for Tree Ensembles” (available at https://arxiv.org/abs/1802.03888, and incorporated by reference herein) describes how SHAP (Shapley additive explanation) values can be calculated for attributes used in a machine learning model, allowing the relative contribution of features 510 to be determined. However, other contextual interpretability measures (which can also be termed contextual contribution values) may be used, such as those calculated using the LIME (local interpretable model-agnostic explanations) technique, described in Ribeiro, et al., “‘Why Should I Trust You?’ Explaining the Predictions of Any Classifier,” available at https://arxiv.org/pdf/1602.04938.pdf, and incorporated by reference herein. In general, a contextual contribution value is a value that considers the contribution of a feature to a machine learning result in the context of other features used in generating the result, as opposed to, for example, simply considering in isolation the effect of a single feature on a result.

Contextual SHAP values can be calculated as described in Lundberg, et al., using as using the equation:

$${ϕ}_{i} = {\sum }_{S ⊆ N \{ i \}} \frac{\vert S \vert ! ( M - \vert S \vert - 1 ) !}{M !} [ {f}_{x} ( S ⋃ \{ i \} ) - {f}_{x} ( S ) ]$$

as defined and used in Lundberg, et al.

A single-variable (or overall) SHAP contribution (the influence of the feature on the result, not considering the feature in context with other features used in the model), ϕ₁, can be calculated as:

ψ_{X}=ϕ₁=log it(\hat{P}(Y|X))−log it(\hat{P}(Y))

### Where:

$$logit ( \hat{P} ( Y \vert X ) ) logit ( \hat{P} ( Y ) ) + {\sum }_{i = 1}^{1} {ϕ}_{i}$$

$$And$$

$$logit ( p ) = log \frac{p}{1 - p}$$

The above value can be converted to a probability scale using:

\hat{P}(Y|X)=s(ψ_{X}+log it(\hat{P}(Y)))

Where s is the sigmoid function:

$$s ( x ) = \frac{1}{1 + {e}^{- x}}$$

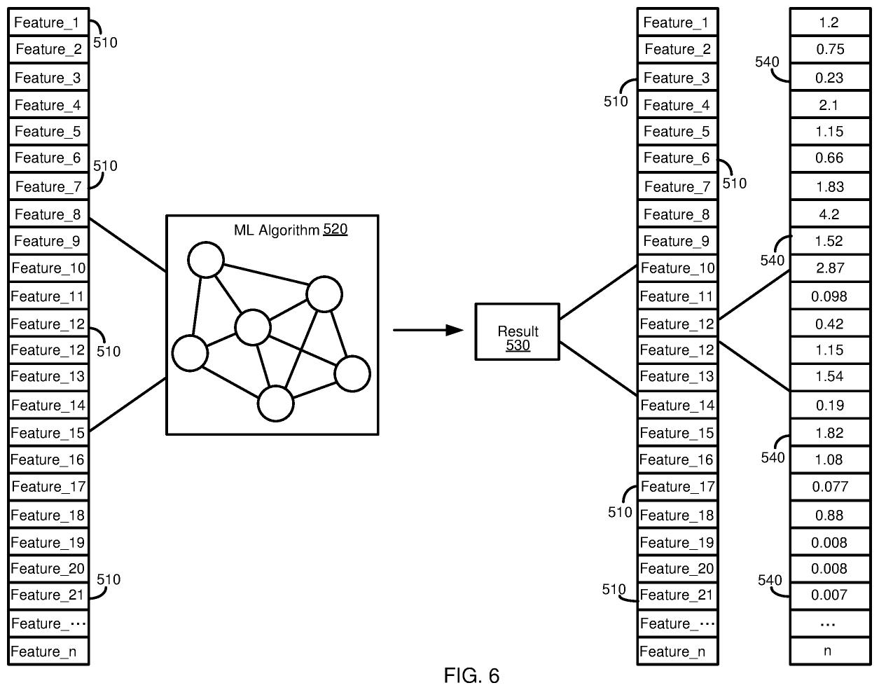

FIG. 6 is generally similar to FIG. 5, but illustrates how contribution values 540 (such as those calculated using the SHAP methodology) can be calculated for features 510. A large number of features 510 are used with many machine learning models. Particularly if the contribution value 540 of each (or most or many) or the features 510 is comparatively small, it can be difficult for a user to understand how any feature contributes to results provided by a machine learning model, including for a particular result 530 of a particular set of values for the features 510.

Similarly, it can be difficult for a user to understand how different combinations of features 510 may work together to influence results of the machine learning model 520.

In some cases, machine learning models can be simpler, such that post-hoc analyses like calculating SHAP or LIME values may not be necessary. For example, at least some regression (e.g., linear regression or the Z-score model described earlier in this disclosure) models can provide a function that provides a result, and in at least some cases a relatively small number of factors or variables can determine (or at least primarily determine) a result. That is, in some cases, a regression model may have a larger number of features, but a relatively small subset of those feature may contribute most to a prediction (e.g., in a model that has ten features, it may be that three features determine 95% of a result, which may be sufficient for explanatory purposes such that information regarding the remaining seven features need not be provided to a user).

As an example, a linear regression model for claim complexity may be expressed as:

Claim Complexity−0.47+10⁻⁶ Capital+0.03 Loan Seniority−0.01 Interest Rate

Using values of 100,000 for Capital, 7 for Loan Seniority, and 3% for Interest Rate provides a Claim Complexity value of 0.75. In this case, global explanation information can include factors such as the overall predictive power and confidence of the model, as well as the variable coefficients for the model (as such coefficients are invariant over a set of analyses). The local explanation can be, or relate to, values calculated using the coefficients and values for a given analysis. In the case above, the local explanation can include that Capital contributed 0.1 to the result, Loan Seniority contributed 0.21, and Interest Rate contributed −0.03.

### Example 7—Example Interactions Between Features of Machine Learning Model

It can also be beneficial to provide a user with information regarding how different data elements of a data collection interact, including as relates to the result of a machine learning model. This information can be used, among other things, to help explain why a particular inference result may indicate that a data collection is or is not likely anomalous (e.g., whether a particular combination of attributes results in a data collection as being anomalous, or whether the anomality results from a single attribute or a collection of attributes considered individually). In some embodiments, a machine learning results can include explanations of relationships between features. These relationships can be determined by various techniques, including using various statistical techniques. One technique involves determining mutual information for pairs of features, which identifies the dependence of the features on one another. However, other types of relationship information can be used to identify related features, as can various clustering techniques.

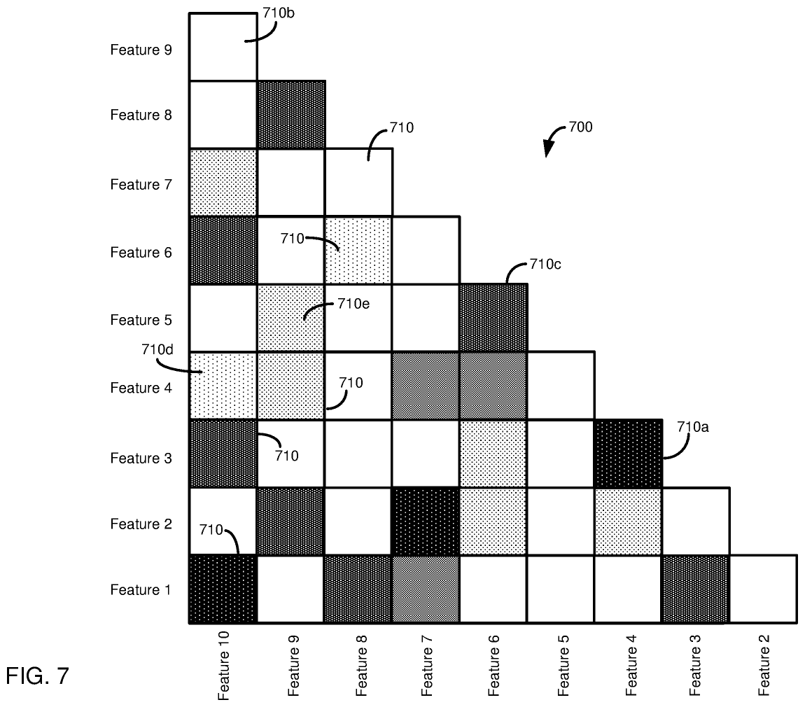

FIG. 7 illustrates a plot 700 (e.g., a matrix) of mutual information for ten features. Each square 710 represents the mutual information, or correlation or dependence, for a pair of different features. For example, square 710a reflects the dependence between feature 3 and feature 4. The squares 710 can be associated with discrete numerical values indicating any dependence between the variables, or the values can be binned, including to provide a heat map of dependencies.

As shown, the plot 700 shows the squares 710 with different fill patterns, where a fill pattern indicates a dependency strength between the pair of features. For example, greater dependencies can be indicated by darker fill values. Thus, square 710a can indicate a strong correlation or dependency, square 710b can indicate little or no dependency between the features, and squares 710c, 710d, 710e can indicate intermediate levels of dependency.

Dependencies between features, at least within a given threshold, can be considered for presentation in explanation information (at least at a particular level of explanation granularity). With reference to the plot 700, it can be seen that feature 10 has dependencies, to varying degrees, on features 1, 3, 4, 6, 7. Thus, a user interface display could provide an indication that feature 10 is dependent on features 1, 3, 4, 6, and 7. Or, feature 4 could be excluded from the explanation, if a threshold was set such that feature 4 did not satisfy the interrelationship threshold. In other embodiments, features having at least a threshold dependence on features 3, 4, 5, 6, 7 could be added to explanation information regarding dependencies of feature 10.

Various criteria can be defined for present dependency information in explanation information, such as a minimum or maximum number of features that are dependent on a given feature. Similarly, thresholds can be set for features that are considered for possible inclusion in an explanation (where features that do not satisfy the threshold for any other feature can be omitted from the plot 700, for example).

Various methods of determining correlation can be used, such as mutual information. Generally, mutual information can be defined as I(X; Y)=D_{KL}(P_{X,Y})∥P_{X}⊗P_{Y}), where X and Y are random variables having a joint distribution P(x) and marginal distributions of P_{X} and P_{Y}. Mutual information can include variations such as metric-based mutual information, conditional mutual information, multivariate mutual information, directed information, normalized mutual information, weighted mutual information, adjusted mutual information, absolute mutual information, and linear correlation. Mutual information can include calculating a Pearson's correlation, including using Pearson's chi-squared test, or using G-test statistics.

When used to evaluate a first feature with respect to a specified (target) second feature, supervised correlation can be used: scorr(X, Y)=corr(ψ_{X}, ω_{Y}), where scorr is Pearson's correlation and ψ_{X}=log it(\hat{P}(Y|X))−log it(\hat{P}(Y)) (binary classification).

In some examples, dependence between two features can be calculated using a modified X² test:

$$cell ( X = x , Y = y ) = \frac{( {O}_{x y} - {E}_{x y} ) \cdot \vert {O}_{x y} - {E}_{x y} \vert}{{E}_{x y}}$$

### Where:

$${E}_{x y} = \frac{{Σ}_{i = 1}^{I} {O}_{i y} {Σ}_{j = 1}^{J} {O}_{x j}}{N}$$

O_{xy} is the observed count of observations of X=x and Y=y, while E_{xy} is the count that is expected if X and Y are independent.

Note that this test produces a signed value, where a positive value indicates that observed counts are higher than expected and a negative value indicates that observed counts are lower than expected.

In yet another implementation, interactions between features (which can be related to variability in SHAP values for a feature) can be calculated as:

$$logit ( \hat{P} ( Y \vert {X}_{1} , {X}_{2} , … {X}_{n} ) ) = logit ( \hat{P} ( Y ) ) + {\sum }_{i , j} {ϕ}_{ij}$$

Where ϕᵢᵢ is the main SHAP contribution of feature i (excluding interactions) and ϕᵢⱼ+ϕⱼᵢ is the contribution of the interaction between variables i and j with ϕᵢⱼ≅ϕⱼᵢ. The strength of an interaction between features can be calculated as:

$${I}_{i j} = 2 \frac{Σ \vert {ϕ}_{i j} \vert + \vert {ϕ}_{j i} \vert}{Σ \vert {ϕ}_{i i} \vert + Σ \vert {ϕ}_{j j} \vert}$$

### Example 8—Example Association Rule Mining

As previously discussed, including in Example 1, if a data collection is found to be potentially anomalous, alternative values can be suggested for one or more data elements of inference data in order to remove the anomaly. Association rule mining is an example technique that can be used to suggest such values. This Example 8 provides an example association rule mining technique that can be used to automatically extract association rules from a data set. Further details of this technique can be found in U.S. Patent Publication 2019/0392075, incorporated by reference herein. Another technique for association rule mining is described in U.S. patent application Ser. No. 16/243,845, incorporated by reference herein.

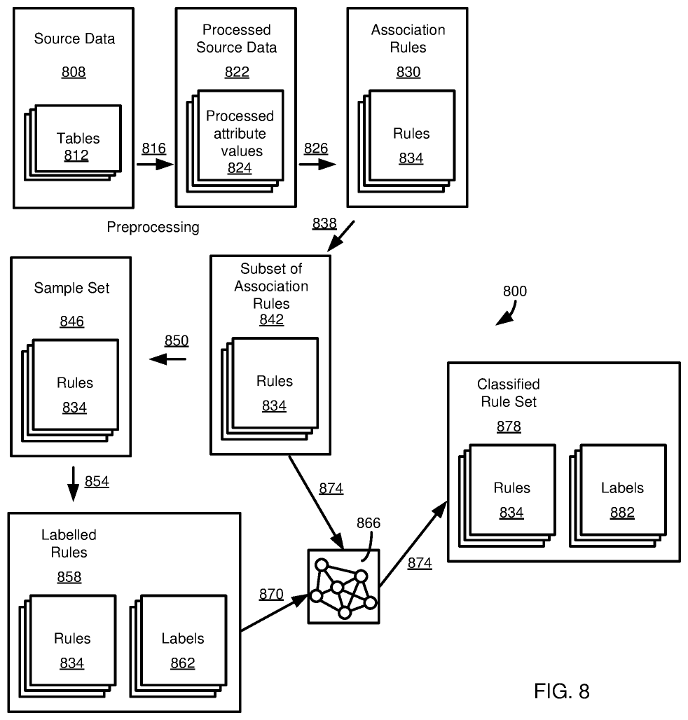

FIG. 8 is a block diagram illustrating a scenario 800 of how data can be preprocessed to reduce computing resource use in determining association rules, how determined rules can be sampled and labelled, and how the sampled rules can be used to train a machine learning algorithm to provide a trained classifier than can be used to analyze the remainder of the association rules, as well as rules that might be produced as a result of further rule extraction.

The scenario 800 includes source data 808. Source data 808 can include data in a database, such as tables 812 of a relational database system. In other aspects, the data can be maintained in another format. When maintained as tables 812, the source data 808 can include schema data, such as attribute names or types, or data related to particular instances of the schema, such as particular tuples or tuple elements. The table data 812 can also include combinations of tuple values and attributes that are analyzed to determine particular rules (e.g., a combination of a value and an identifier of an attribute with which the value is associated).

In at least some cases, rules are formed between antecedents (e.g., attribute values on the left hand side of the rule) and consequents (e.g., attribute values on the right hand side of the rule). A rule can be that one or more attributes having a value (or range or set of values) are associated with one or more attributes having a value (or a range or set of values). Typically, an attribute appears either as an antecedent or a consequent, but not both.

However, prior to rule determination or extraction, the source data 808 can undergo a preprocessing step (which can include one or more discrete operations) 816 to provide processed source data 822, which can include processed attribute values 824. The preprocessing 816 can include selecting certain attributes to be analyzed. For example, in a table that includes twenty attributes, it may be that ten attributes are most likely to yield useful rules, or yield useful rules for a specific purpose (and perhaps other attributes may be useful for a different specific purpose). If desired, other portions of a table, such as particular partitions, can be selected for analysis and other portions not included.

In some cases, user input can be used to determine which attributes (or other source data 808) to be included for analysis, and the preprocessing 816 can include receiving such user input and selecting the appropriate source data 808 for further analysis. In other cases, all or a portion of the source data 808 to be further processed can be selected automatically. For example, the source data 808 can be analyzed to determine whether certain data should or can be excluded from further analysis.

Redundant, or non-diverse, data is one type of data that can be analyzed and automatically excluded, or information about redundancy presented to a user so that the user can choose whether to include the data.

In a particular example, the preprocessing at 816 can include calculating the entropy of attribute values for particular source data 808. Entropy can be calculated as:

H(X)=Σᵢ₌₁ⁿP(xᵢ)I(xᵢ)=−Σᵢ₌₁ⁿP(xᵢ)log_{b}P(xᵢ) (1)

where P(xᵢ) is the probability mass function of a particular value xᵢ (using a probably mass function P(X) for variable X) and b is the log base (e.g., 2, e, 10). The range of entropy values can be between 0 and 1, with 1 being maximum entropy (highest information diversity) and 0 being minimum entropy (lowest information diversity).

In some cases, threshold entropy values can be set, such that an attribute is not selected for analysis if it does not satisfy a threshold. In other cases, threshold values can be used to determine that columns having entropy values satisfying the threshold are always selected for analysis. In a particular example, a threshold can be selected, including dynamically, based on a particular data set. For example, a plot can be made of a number of columns having an entropy value above particular values (x-axis). In some cases, an inflection point (or a point where a pronounced change in slope or trend occurs) can be determined, where a number of columns having an entropy value above the value has a more pronounced difference than a number of columns having an entropy value below the value. This inflection point can be set as the entropy threshold. Thus, the entropy threshold can be set based on diversity differences in particular datasets. In other cases, a combination of approaches can be used, such as selecting all attributes having an entropy satisfying a threshold, not selecting attributes not satisfying another threshold, and using another technique, such as graphical analyze, to determine other attributes that will be selected for analysis.

Preprocessing at 816 can also include formatting data for use in rule determination. For example, association rule mining techniques typically cannot be directly applied to numerical values. So, columns having numerical values can be discretized into intervals. The number of intervals, and interval definitions, can be automatically selected or can be user-configurable. In some cases, intervals can be regular, and in other cases intervals can be irregular. For example, intervals can be defined that have meanings such as “low,” “medium,” and “high,” and a number of values that are considered “high” may be different than a number of values that are considered “medium.” The number of intervals can be fixed, or can be selected based on a number of discrete values in a column, or a measure of value diversity in a column.

One technique that can be used to discretize numerical values is k-means clustering. However other discretization techniques can be used, including x-means clustering, Equal-Frequency, or Equal-Width. K-means clustering can be advantageous in that the original contribution of numeric data can be retained, and the intervals are typically more meaningful. Or, as described, intervals can be manually assigned or evenly or regularly spaced intervals can be determined for a particular value range (such as between the minimum and maximum values for the attribute represented in the source data 808). In some cases, including for use in k-means clustering, an optimal value of k can be determined using the Elbow method, Akaike information criterion, Bayesian information criterion, Deviance information criterion, rate distortion theory, the silhouette method, or using cross-validation.

Preprocessing at 816 can further include grouping attributes by transaction (e.g., selecting relevant attributes from particular tuples) and compression or encoding techniques. For example, processing may be more efficient if attribute values, particularly long strings or character arrays, are replaced with an identifier that codes for a particular attribute with a particular value (e.g., using dictionary encoding). For example, a value of “Name=WeiHan” may be replaced by “1” when it occurs, and “Name=MarcusAdam” may be replaced by “2” when it occurs. Correspondingly, a value of “Supervisor=WeiHan” may be replaced by “3” when it occurs, as that value involves a different attribute than “1,” even though the attribute value is the same.

Association rule determination, or mining, is carried out at 826 on the processed source data 822. Any suitable association rule mining technique can be used, including the APRIORI algorithm. Other suitable techniques include ECLAT, FP-growth, AprioriDP, Context Based Association Rule Mining, Node-set-based algorithms (such as FIN, PrePost, and PPV), GUHA (including ASSOC), and OPUS. Other types of rule mining may also be used, including multi-relation association rule mining, context based association rule mining, contrast set learning, weighted class learning, high-order pattern disclosure, K-optimal pattern discovery, approximate frequency itemset mining, generalized association rule mining, quantitative association rule mining, interval data association rule mining, sequential pattern mining, subspace clustering, and Warmr data mining.

The association rule determination 826 produces an initial association rule set 830, which includes a plurality of association rules 834. The plurality of association rules 834 can include redundant rules. A rule can be classified as redundant if it can be generated by adding additional items to another rule. Non-redundant rules can be those rules that are the most general, having equal confidence. For example, a rule R1 of B+D→A+C is redundant to a rule R2 of B+D→A. Similarly, a rule R3 of C+B+D→A is redundant to R2 (all the confidence of R1, R2 and R3 is 1.0). In some cases, a rule is marked as redundant only if its confidence is the same as, or less than, a more general rule.

Redundant rules can be removed from the initial association rule set 830 in a process 838 to produce a rule subset 842 typically having a reduced number of rules 834 (that is, there may be some circumstances when the association rules 830 did not include redundant rules). In particular examples, and depending on how attributes were selected (e.g., how many potentially redundant or low-diversity columns were removed prior to rule mining), removing redundant rules can reduce the number of rules by a quarter, a third, a half, 90%, or more.

The rule subset 842 typically contains rules 834 that are desired to be classified, such as of being of potential interest to a user. As has been described, it can be difficult for a user to manually evaluate every rule 834 in the subset 842. For example, a subset 842 may include hundreds or thousands of rules 834. Accordingly, a sample set 846 of rules 834 can be extracted from the subset 842 in a sampling process 850. The sampling process 850 can include random sampling methods, methods to obtain representative rules, methods to select diverse rules (including the most diverse rules 834), or a combination thereof. The selected rules can be manually evaluated for use as training data for a machine learning algorithm.

In particular aspects, the sampling process 850 can include determining differences between rules, and using those differences in extracting samples. Briefly, differences between rules can be expressed as the Jaccard distance. The Jaccard distances can be used in techniques such as clustering-based sampling (including agglomerative hierarchy clustering or K-Medoid Clustering) or Convex-Hull sampling to retrieve rules 834 from the subset 842. However, in other aspects, another distance determination technique can be used to measure similarity or dissimilarity between rules, or similarity or dissimilarity can otherwise be evaluated in another manner.

The rules 834 in the sample set 846 can be labelled in a process 854 to provide a labelled ruleset 858 of rules 834 and their associated labels 862. The process 854 can include a user interface that presents a user, such as a subject matter expert, with the rules 834 in the sample set 846 and allows that user to tag each rule with an identifier representing the interestingness, usefulness, or other criteria of interest for the rule. For example, the rules 834 may be tagged using a numerical scale (e.g., between 1 and 3, and 1 and 5, or 1 and 10, based on level of interestingness or criteria satisfaction), or can be tagged using semantic identifiers (such as “high,” “medium,” and “low”).

As the sample set 846 is used for training a machine learning algorithm to serve as a classifier, the labels applied during the labelling process 854 are typically the labels which are desired for the classifier to assign to other rules of the rule subset 842 (or future rules to be evaluated). In some cases, a rule is “interesting” if it is unexpected, such as being unknown to someone in the field, or contradicting their expectations, or if there is some action that can be taken as a result of the rule that improves quality, efficiency, performance, or some other metric of interest.

The rules 834 and labels 862 of the labelled rules 858 are used to train a machine learning algorithm 866 in a training process 870. In a classification process 874, the machine learning algorithm 866 serves as a classifier that evaluates the rules 834 in the subset 842. The classification process 874 can produce a classified set 878 of rules 834 and associated labels 882. The rules 834 and labels 882 can be presented to a user.

Any suitable machine learning technique 866 can be used to generate a classifier. Suitable techniques include classification and regression techniques, including ensemble learning methods and decision trees. One particularly suitable class of techniques is random subspace methods, such as random forests or random decision forests. Details regarding a suitable random forest technique can be found in Brieman, L., “Random Forests,” Machine Learning 45(1):5-32 (October 2001), incorporated by reference herein in its entirety.

In some cases, labels applied to rules may be skewed, in that there may be, for example, a larger number of uninteresting rules than interesting rules. Classifier training can account for these differences to help ensure that “interesting” rules are not labelled as “uninteresting” merely to maintain a distribution that was present in the training data. Training data can thus be weighed, such as in a weighted random forests techniques, to help reduce such skew, and to place more “importance” on “interesting” rules. In a particular example, a weighting of 7:3 of “interesting” to “uninteresting” is used. In addition to increased accuracy, weighting of training data can provide improved F−1 measure, precision, and recall. In other cases, accuracy can be reduced using weighting, but other classifier performance metrics can be improved.

### Example 9—Example Computing Architecture for Obtaining Anomaly Scores

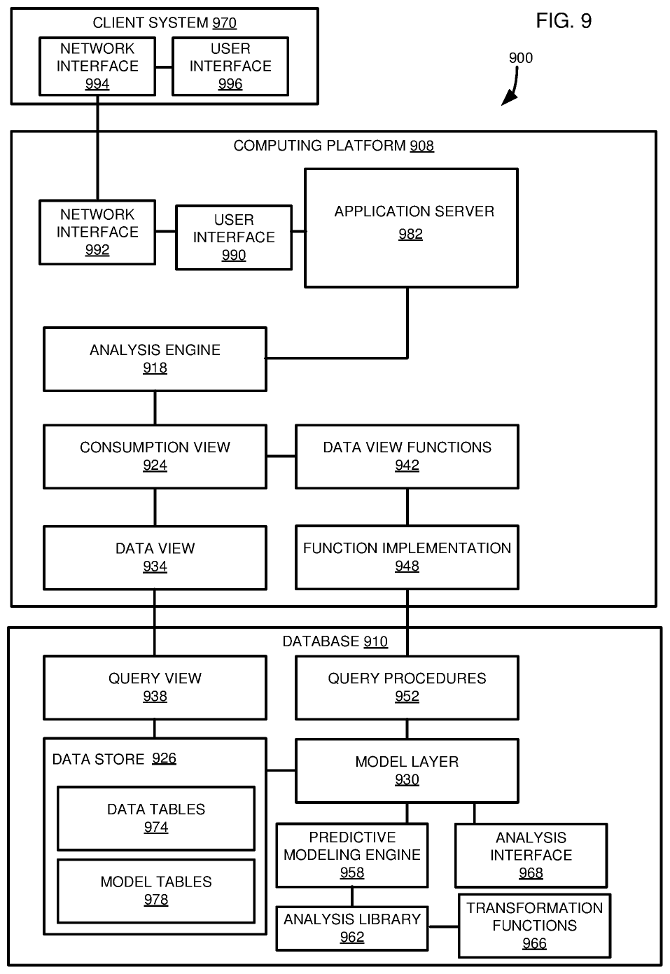

FIG. 9 is a block diagram providing an example software architecture 900 that can be used in implementing at least certain embodiments of the present disclosure. The architecture 900 includes a computing platform 908 and a database 910. In specific examples, the computing platform 908 can be the S/4 HANA platform, and the database 910 can be the HANA database system, both of SAP SE of Walldorf, Germany.

The computing platform 908 can include an analysis engine 918. The analysis engine 914 can analyze one or more data collections to obtain an inference resulting indicating if the given data collection may be anomalous. In some cases, the analysis engine 914 can perform various operations in the method 300 of FIG. 3A or in the method 350 of FIG. 3B. For example, the analysis engine 914 can perform operations such as preprocessing data, which can be training data or inference data. The analysis engine 914 can also be responsible for coordinating other activities of the cloud platform 908, such as retrieving data (inference data or training data) and calling machine learning components for conducting model training or requesting inference results, including using machine learning components of the database 910, which will be further described.

The analysis engine 914 can communicate with a consumption view 924 that can be generated using data stored in a data store 926 of the database 910 and the results of analyzing a model associated with an analysis procedure of the analysis engine 914. The model can be maintained and defined in a model layer 930 of the database 910. The consumption view 924 can represent a compilation of data and, optionally, transformation of the data into a format that can be read and manipulated by the analysis engine 914 and other components of the architecture 900. In particular implementations, the consumption view 924 provides an interface for requests, such as requests using the ODATA protocol, from the analysis engine 914, including requests originating at other components of the architecture 900. In a specific example, the consumption view 924 can be a CORE DATA SERVICES CONSUMPTION VIEW provided by the HANA database system and S/4 HANA platform of SAP SE of Walldorf, Germany. The consumption view 924, in some cases, can be programmed to transform non-numeric attributes into numeric attributes, as described in the method 300, including by determining a number of unique values associated with particular attributes, overall, or with particular attributes for particular data collections in a set of training data.

The consumption view 924 can be generated in part from a data view 934, such as a CORE DATA SERVICES VIEW provided by the HANA database system and S/4 HANA platform of SAP SE of Walldorf, DE. The data view 934 can be a design-time object that aggregates, formats, or otherwise manipulates or presents data from one or more data sources. For example, the data view 934 can be constructed from one or more query views 938 provided by the database 910. For example, a query view 938 may represent a table, such as virtual table, generated from the response to a query request processed by the database 910, such as using structured query language (SQL) statements to retrieve data from the data store 926. In a specific example, the query view 938 can be a SQL VIEW provided by the SAP HANA database system, in particular the SAP HANA EXTENDED APPLICATION SERVICES, of SAP SE of Walldorf, Germany. The query view 938 can be used to obtain training data or inference data from the database 910.

The consumption view 924 can also include data provided by predictive analytics (including machine learning algorithms) associated with an analysis being executed or managed by the analysis engine 914. In a particular example, the consumption view 924 can include or be associated with functions that define data to be included in the consumption view. The functions can be maintained by a data view functions component 942 which, in particular examples, can be a CDS TABLE FUNCTION of the S/4 HANA platform of SAP SE of Walldorf, DE. The data view function component 942 can, for example, allow structured query language functions to be included in the consumption view 924.

A particular function of the data view function component 942 can be associated with an object implementing the function associated with, or stored in, a function implementation component 948. In a particular example, the functions can be implemented in the ABAP programming language, such as an ABAP managed database procedure that can be used to manage or call stored procedures maintained in the database 910. More particularly, the function implementation 948 can be in communication with, and call or manage procedures stored in, a query procedures store 952 of the database 910.

At least a portion of the query procedures of the query procedure store 952 can interact with the model layer 930. For example, procedures of the query procedure store 952 can retrieve, and optionally manipulate, data associated with a model maintained by the model layer 930. In at least some cases, other components of the computing platform 908 can interact with the model layer 930, such to create, edit, manage, or delete models. In other cases, other components of the architecture 900 (including components not specifically illustrated in FIG. 9) can interact with the model layer 930 to carry out such actions.

In at least some cases, the model layer 930 can provide a framework for creating and manipulating models within the architecture 900, including models that can be used for predictive modeling, or models that can be used for other purposes. In a particular implementation, the model layer 930 is, or includes, the UMML4HANA or PREDICTIVE ANALYSIS INTEGRATION frameworks of SAP SE of Walldorf, Germany. Models in the model layer 930 can be models described in Example 4, including models based on a Z-score or various types of classifiers, including neural networks.

The model layer 930 can communicate with a predictive modeling engine 958 to carry out analyses associated with a model. In some cases, the predictive modeling engine 958 can execute analysis procedures stored in an analysis library 962. In particular examples, the analysis library can be the AUTOMATED PREDICTIVE LIBRARY, the PREDICTIVE ANALYSIS LIBRARY, or the APPLICATION FUNCTION LIBRARY of SAP SE of Walldorf, Germany. Non-limiting examples of predictive analysis techniques that can be used by the predictive modeling engine 958 include clustering, classification, regression, association, time series, preprocessing, statistics (including calculating Z-scores), social network analysis, and combinations thereof. In particular cases, the predictive analysis can include a machine learning component. Suitable machine learning techniques can include decision trees, artificial neural networks, instance-based learning, Bayesian methods, reinforcement learning, inductive logic programming, genetic algorithms, support vector machines, or combinations thereof.

The analysis library 962 can include, or can be in communication with, transformation functions 966. Transformation functions 966 can include functions for converting non-numeric data elements to numeric data elements, including as described in Example 4, by creating positionally-encoded representations of strings, for converting positionally-encoded string representations back to string form, or for performing dictionary encoding of non-numeric data elements. In at least some implementations, the transformation functions 966, and/or the analysis library 962, can be accessed without accessing the predictive modeling engine 958. For instance, the analysis library 962 or transformation functions 966 can be accessed by query procedures 952, the model layer 930, or the analysis engine 918.

The model layer 930 can optionally be in communication with an analysis interface 968. In some implementations, the analysis interface 968 can allow for creation or manipulation of models of the model layer 930. For example, the analysis interface 968 can be in communication with a client system 970. In further implementations, the analysis interface 968 can provide access to additional analysis tools or components. For instance, the analysis interface 968 can use machine learning capabilities provided by AMAZON WEB SERVICES (Seattle, Wash.), GOOGLE CLOUD PLATFORM (Google Inc., Mountain View, Calif.), MICROSOFT COGNITIVE SERVICES (Microsoft Corp, Redmond, Wash.), HPE HAVEN ON DEMAND (Hewlett Packard Enterprise Development LP, Palo Alto, Calif.), and IBM WATSON SERVICES ON BLUEMIX (IBM Corp., Armonk, N.Y.).

The data store 926 of the database 910 can include data, such as data used in a process associated with the analysis engine 914. For example, the data can be stored in data tables 974. The data store 926 can also include data to be used by the model layer 930. In some cases, the model layer 930 can directly access data in the data tables 974. In other cases, the database 910 can maintain data associated with the model layer 930 in model tables 978.

Returning to the computing platform 908, the analysis engine 914 can be in communication with an application server 982 or similar component for providing access to the analysis engine 914 to a user or external applications. The application server 982 can include specific components to execute functionality associated with the analysis engine 914. The application server 982 can be in communication with a user interface component 990 that can send information to, and receive information from, the client system 970, such as through a network interface 992. The user interface 990 can process commands for execution by the application server 982, or format information for consumption by the client system 970.

The client system 970 can include a network interface 994 for communicating with other components of the architecture 900, including the computing platform 908. Although not shown, in some embodiments, the client system 970 can directly communicate with the database 910. The network interface 994 can communicate with a user interface 996. The user interface 996 can be used to display information to a user and to receive user commands in interacting with an analysis managed by the analysis engine 914.

The architecture 900 can include more or fewer components than shown, and may be organized in other manners. For example, functionality of a particular component can be carried out by another component. In addition, in at least some cases, functionality can be carried out using multiple components. In a specific example, the functionality of two or more of the client system 970, the computing platform 908, and the database 910 can be combined in a single system. For instance, although in some cases the computing platform 908 can be a cloud platform, in other cases the functionality can be included in a non-cloud based system, including in a computing system that integrates functions of the computing platform with functions of the client system 970. The database 910 can be separate from a combined client system 970/computing platform 908, or can be further integrated into such combined system.

### Example 10—Example Operations for Obtaining an Anomaly Score for an Inference Data Collection

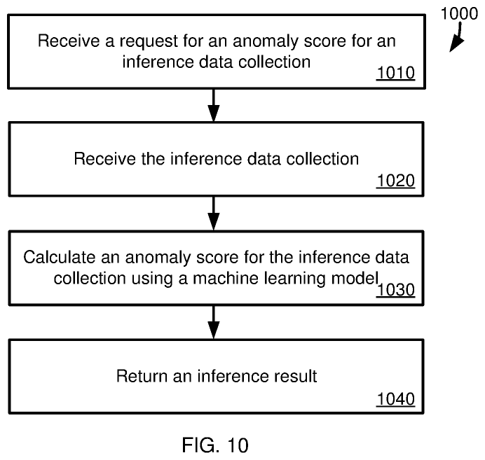

FIG. 10 is a flowchart of an example method 1000 of obtaining an inference result for an inference data collection having a plurality of data elements (also referred to as features), where the inference result includes one or more values indicating whether the inference data collection, or values for data elements thereof, may be anomalous. The method 1000 can be carried out using the architecture 900 of FIG. 9, and can implement the process 350 of FIG. 3B, including using a machine learning model trained using the process 300 of FIG. 3A.

At 1010, a request for an anomaly score for an inference data collection is received. The inference data collection is received at 1020. The inference data collection includes a plurality of features, each feature being associated with a data type, such as a numerical data type or a non-numerical data (e.g., a categorical data type). The inference data collection can be an instance of one or more types of structured data.

At 1030, an anomaly score for the inference data collection is calculated using a machine learning model. The anomaly score indicates a relative difference between the inference data collection and a plurality of training data collections used to train the machine learning model. The anomaly score represents a combination of feature anomaly scores for at least a portion of the features of the inference data collection, where the training data collections also comprise the plurality of features. An inference result is returned at 1040 in response to the request. The inference result incudes at least a portion of the feature anomaly scores.

### Example 11—Computing Systems

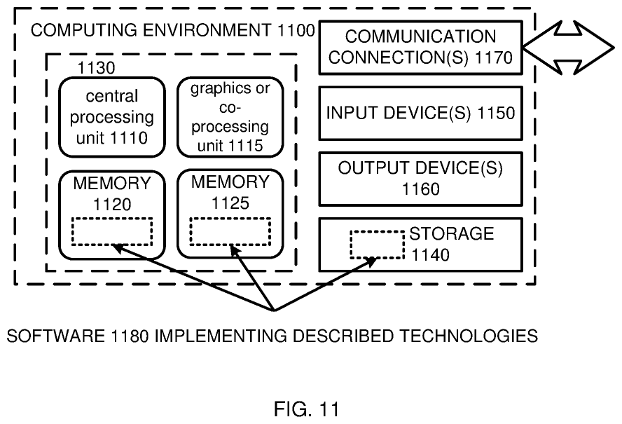

FIG. 11 depicts a generalized example of a suitable computing system 1100 in which the described innovations may be implemented. The computing system 1100 is not intended to suggest any limitation as to scope of use or functionality of the present disclosure, as the innovations may be implemented in diverse general-purpose or special-purpose computing systems.

With reference to FIG. 11, the computing system 1100 includes one or more processing units 1110, 1115 and memory 1120, 1125. In FIG. 11, this basic configuration 1130 is included within a dashed line. The processing units 1110, 1115 execute computer-executable instructions, such as for implementing the technologies described in Examples 1-10. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 11 shows a central processing unit 1110 as well as a graphics processing unit or co-processing unit 1115. The tangible memory 1120, 1125 may be volatile memory (e.g., registers, cache, RAM), non-volatile memory (e.g., ROM, EEPROM, flash memory, etc.), or some combination of the two, accessible by the processing unit(s) 1110, 1115. The memory 1120, 1125 stores software 1180 implementing one or more innovations described herein, in the form of computer-executable instructions suitable for execution by the processing unit(s) 1110, 1115.

A computing system 1100 may have additional features. For example, the computing system 1100 includes storage 1140, one or more input devices 1150, one or more output devices 1160, and one or more communication connections 1170. An interconnection mechanism (not shown) such as a bus, controller, or network interconnects the components of the computing system 1100. Typically, operating system software (not shown) provides an operating environment for other software executing in the computing system 1100, and coordinates activities of the components of the computing system 1100.

The tangible storage 1140 may be removable or non-removable, and includes magnetic disks, magnetic tapes or cassettes, CD-ROMs, DVDs, or any other medium which can be used to store information in a non-transitory way and which can be accessed within the computing system 1100. The storage 1140 stores instructions for the software 1180 implementing one or more innovations described herein.

The input device(s) 1150 may be a touch input device such as a keyboard, mouse, pen, or trackball, a voice input device, a scanning device, or another device that provides input to the computing system 1100. The output device(s) 1160 may be a display, printer, speaker, CD-writer, or another device that provides output from the computing system 1100.

The communication connection(s) 1170 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

In various examples described herein, a module (e.g., component or engine) can be “coded” to perform certain operations or provide certain functionality, indicating that computer-executable instructions for the module can be executed to perform such operations, cause such operations to be performed, or to otherwise provide such functionality. Although functionality described with respect to a software component, module, or engine can be carried out as a discrete software unit (e.g., program, function, class method), it need not be implemented as a discrete unit. That is, the functionality can be incorporated into a larger or more general purpose program, such as one or more lines of code in a larger or general purpose program.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 12—Cloud Computing Environment

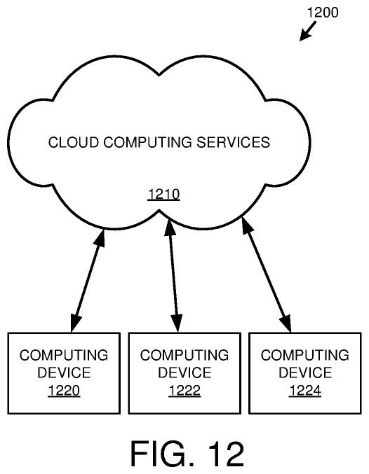

FIG. 12 depicts an example cloud computing environment 1200 in which the described technologies can be implemented. The cloud computing environment 1200 comprises cloud computing services 1210. The cloud computing services 1210 can comprise various types of cloud computing resources, such as computer servers, data storage repositories, networking resources, etc. The cloud computing services 1210 can be centrally located (e.g., provided by a data center of a business or organization) or distributed (e.g., provided by various computing resources located at different locations, such as different data centers and/or located in different cities or countries).

The cloud computing services 1210 are utilized by various types of computing devices (e.g., client computing devices), such as computing devices 1220, 1222, and 1224. For example, the computing devices (e.g., 1220, 1222, and 1224) can be computers (e.g., desktop or laptop computers), mobile devices (e.g., tablet computers or smart phones), or other types of computing devices. For example, the computing devices (e.g., 1220, 1222, and 1224) can utilize the cloud computing services 1210 to perform computing operators (e.g., data processing, data storage, and the like).

### Example 13—Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 11, computer-readable storage media include memory 1120 and 1125, and storage 1140. The term computer-readable storage media does not include signals and carrier waves. In addition, the term computer-readable storage media does not include communication connections (e.g., 1170).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, C#, Java, Perl, JavaScript, Python, Ruby, ABAP, SQL, XCode, GO, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present, or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computing system comprising:
memory;
one or more processing units coupled to the memory; and
one or more computer readable storage media storing instructions that, when loaded into the memory and executed by the one or more processing units, cause the one or more processing units to perform operations for:
receiving a request for an anomaly score for an inference data collection;
receiving the inference data collection, the inference data collection comprising a plurality of features, each feature being associated with a data type;
calculating an anomaly score for the inference data collection using a machine learning model, wherein the anomaly score indicates a relative difference between the inference data collection and a plurality of training data collections used to train the machine learning model, the anomaly score representing a combination of feature anomaly scores for at least a portion of the features of the inference data collection, wherein the training data collections comprise the plurality of features; and
returning an inference result in response to the request, the inference result comprising at least a portion of the feature anomaly scores.

2. The computing system of claim 1, wherein the plurality of features comprise at least one non-numeric feature and the operations further comprise:
encoding the at least one non-numeric feature as a plurality of encoded numeric features.

3. The computing system of claim 2, wherein a number of the plurality of encoded numeric features is equal to a number of distinct values for the at least one non-numeric feature.

4. The computing system of claim 3, wherein a value of an encoded numeric feature of the plurality of encoded numeric features is set to one for the inference data collection or a training data collection of the plurality of training data collections if a value of the inference data collection or the training data collection for the at least one non-numeric feature is equal to a distinct value of the number of distinct values for the at least one non-numeric attribute, and is set to zero otherwise.

5. The computing system of claim 2, wherein the trained model comprises a mean and a standard deviation for the at least a portion of the plurality of features, the mean and the standard deviation being calculated from the plurality of training data collections and the feature anomaly score for the at least one non-numeric feature being calculated as an aggregation of Z-scores for the plurality of encoded numeric features.

6. The computing system of claim 1, the operations further comprising:
applying a weighting factor to the feature anomaly score for the at least one non-numeric feature, the weighting factor based at least in part on a number of discrete values available for the at least one non-numeric feature.

7. The computing system of claim 1, wherein the anomaly score is calculated as a norm of the feature anomaly scores.

8. The computing system of claim 7, wherein the norm is calculated as the Euclidian norm.

9. The computing system of claim 1, wherein the machine learning model comprises a classifier and the feature anomaly scores are determined from the anomaly score.

10. The computing system of claim 1, the operations further comprising:
determining that the anomaly score exceeds a threshold;
determining at least one feature anomaly score that satisfies a threshold contribution to the anomaly score; and
determining an alternative value for the feature associated with the at least one feature anomaly score.

11. The computing system of claim 10, wherein determining an alternative value for the feature associated with the at least one feature anomaly score is based at least in part on an association rule that comprises the feature associated with the at least one feature anomaly score.

12. The computing system of claim 10, wherein the alternative value is based at least in part on parameters associated with the machine learning model.

13. The computing system of claim 1, wherein the inference result comprises the anomaly score and an indication of whether the inference data collection satisfies anomaly criteria.

14. The computing system of claim 1, wherein the at least a portion of the feature anomaly scores is selected as features of the plurality of feature anomaly scores satisfying selection criteria.

15. The computing system of claim 1, wherein the inference result comprises relative contributions of features associated with the at least a portion of the feature anomaly scores to the anomaly score.

16. The computing system of claim 1, wherein the inference result comprises information comparing the inference result with the training data collection.

17. The computing system of claim 16, wherein the information comparing the inference result with the training data collection comprises a relative anomaly score comparing the anomaly score with a reference anomaly score or identifying how the anomaly score compares with a distribution of anomaly scores for the plurality of training data collections.

18. The computing system of claim 1, wherein the inference result comprises identifiers for data types of features associated with the at least a portion of the feature anomaly scores.

19. One or more computer-readable storage media comprising computer-executable instructions for causing a computing system programmed thereby to perform operations comprising:
receiving a request for an anomaly score for an inference data collection;
receiving the inference data collection, the inference data collection comprising a plurality of features, each feature being associated with a data type;
calculating an anomaly score for the inference data collection using a machine learning model, wherein the anomaly score indicates a relative difference between the inference data collection and a plurality of training data collections used to train the machine learning model, the anomaly score representing a combination of feature anomaly scores for at least a portion of the features of the inference data collection, wherein the training data collections comprise the plurality of features; and
returning an inference result in response to the request, the inference result comprising at least a portion of the feature anomaly scores.

20. A method, implemented in a computing system comprising a memory and one or more processors, comprising:
receiving a request for an anomaly score for an inference data collection;
receiving the inference data collection, the inference data collection comprising a plurality of features, each feature being associated with a data type;
calculating an anomaly score for the inference data collection using a machine learning model, wherein the anomaly score indicates a relative difference between the inference data collection and a plurality of training data collections used to train the machine learning model, the anomaly score representing a combination of feature anomaly scores for at least a portion of the features of the inference data collection, wherein the training data collections comprise the plurality of features; and
returning an inference result in response to the request, the inference result comprising at least a portion of the feature anomaly scores.
